(19) United States
(12) Patent Application Publication
(10) Pub. No.: US 2015/0336450 A1
(43) Pub. Date: Nov. 26, 2015

(54) VEHICLE CEILING

(71) Applicant: HOWA TEXTILE INDUSTRY CO., LTD., Kasugai-shi (JP)

(72) Inventors: Takumi Aoki, Kasugai-shi (JP); Shuichi Mizata, Kasugai-shi (JP)

(73) Assignee: HOWA TEXTILE INDUSTRY CO., LTD.

(21) Appl. No.: 14/630,932

(22) Filed: Feb. 25, 2015

(30) Foreign Application Priority Data
May 23, 2014 (JP) 2014107252

(51) Int. Cl. B60J 7/06

(52) U.S. Cl. CPC B60J 7/067

(57) ABSTRACT

A vehicle ceiling includes a roof panel, a ceiling member attached to the roof panel to face toward a vehicle interior and an opening/closing mechanism attached to the ceiling member. The ceiling member is formed with an opening that corresponds with an aperture in the roof panel. The opening/closing mechanism is configured to deploy and reciprocate a sheet member between in a closed state and an open state. The sheet member, in the closed state, covers the opening in the ceiling member to suppress light entrance into the vehicle interior. The sheet member, in the open state, is stowed away from the opening in the ceiling member to permit light entrance into the vehicle.

This application claims priority to Japanese patent application serial number 2014-107252, the contents of which are incorporated herein by reference in their entirety.

### BACKGROUND

Embodiments of the present invention relate to a vehicle ceiling. More specifically, the present invention relates to deployment of a sheet member to cover an opening in a vehicle ceiling of a vehicle such as a minivan, sports utility vehicle (SUV), a sports activity vehicle (SAV), a sedan car and/or any type of car.

Japanese Laid-Open Patent Publication No. 2011-5895 discloses a vehicle roof and/or ceiling with a roof panel, a ceiling member, and an opening/closing mechanism configured to open or close a sunroof opening defined in the roof panel. The ceiling member is attached to the roof panel to face an interior of the vehicle. An opening is formed in the ceiling member to correspond with the sunroof opening. The opening/closing mechanism is equipped with a sheet member covering the openings. A sheet member is positioned to cover at least a portion of the opening/closing mechanism, and may cycle between a closed position and an open position. The sheet member, when in the closed position, covers the opening and/or the sunroof opening to block and/or suppress light entrance into, for example, the vehicle interior. The sheet member, when in the open position, is positioned at a distance away from the opening to permit light to enter into the vehicle interior. The opening/closing mechanism may be a rail unit constructed from a rigid material such as of metal and/or the like. The sheet member is attached to and/or configured with the roof panel via the rail unit. The rail unit directs the sheet member to slide along the roof panel to, for example, move along with the sunroof opening to control light entrance into the interior of the vehicle.

A worker, such as an assembly line worker, must face in a generally upward direction, i.e. toward the sunroof opening, to attach the opening/closing mechanism as needed to the roof panel. Similarly, to attach the roof panel to the ceiling member, the worker must again face upward. However, maneuvering within, for example, an assembly line to face upward toward the sunroof opening may be difficult for the worker given manufacturing space constraints. Thus, there has been a need in the art to conveniently attach an opening/closing mechanism and/or a ceiling member to a vehicle ceiling.

### SUMMARY

The present invention generally relates to a vehicle ceiling in, for example, an SUV and/or a minivan. The vehicle ceiling may include a roof panel, a ceiling member and an opening/closing mechanism configured to open, close and/or otherwise move the sunroof in and/or relative to the vehicle ceiling. The ceiling member may attach to the roof panel to generally face toward a vehicle interior. The ceiling member may be constructed with an opening positioned, for example, at a center of the ceiling member to correspond with an analogous opening and/or aperture in the roof panel. The opening/closing mechanism may attach to the ceiling member and include a sheet member that may reciprocate between a closed state and an open state. The sheet member, in the closed state, may move and/or expand to cover the opening formed in the ceiling member and/or roof panel to suppress, control and/or reduce entrance of light into the vehicle interior through the opening in the ceiling member and/or roof panel. Likewise, the sheet member, in the open state, may recede away from the opening to allow entrance of light into the vehicle interior through the opening in the ceiling member and/or roof panel.

As described above, the opening/closing mechanism may be attached to the ceiling member. In detail, the opening/closing mechanism may be positioned as needed and integrally attached to both the ceiling member and the roof panel simultaneously, thus allowing for a convenient and efficient installation in a vehicle.

### BRIEF DESCRIPTION OF THE DRAWINGS

FIG. 1 is an exploded perspective of a vehicle ceiling;

FIG. 2 is a plan view of a ceiling member;

FIG. 3 is an enlarged view of a portion III in FIG. 1; and

FIG. 4 is a cross-sectional view taken along line IV-IV in FIG. 2,

### DETAILED DESCRIPTION

Each of the features and teachings disclosed may be used separately or in conjunction with other features and teachings to provide an improved vehicle ceiling. Representative examples of the present invention will be described in farther detail with reference to the attached drawings. This detailed description is intended to teach a person of ordinary skill in the art details for practicing aspects of the present teachings and is not intended to limit the scope of the invention. Only the claims define the scope of the claimed invention. Moreover, various features of the representative examples and claims may be combined in ways that may not be specifically enumerated to provide additional useful configurations of the present teachings.

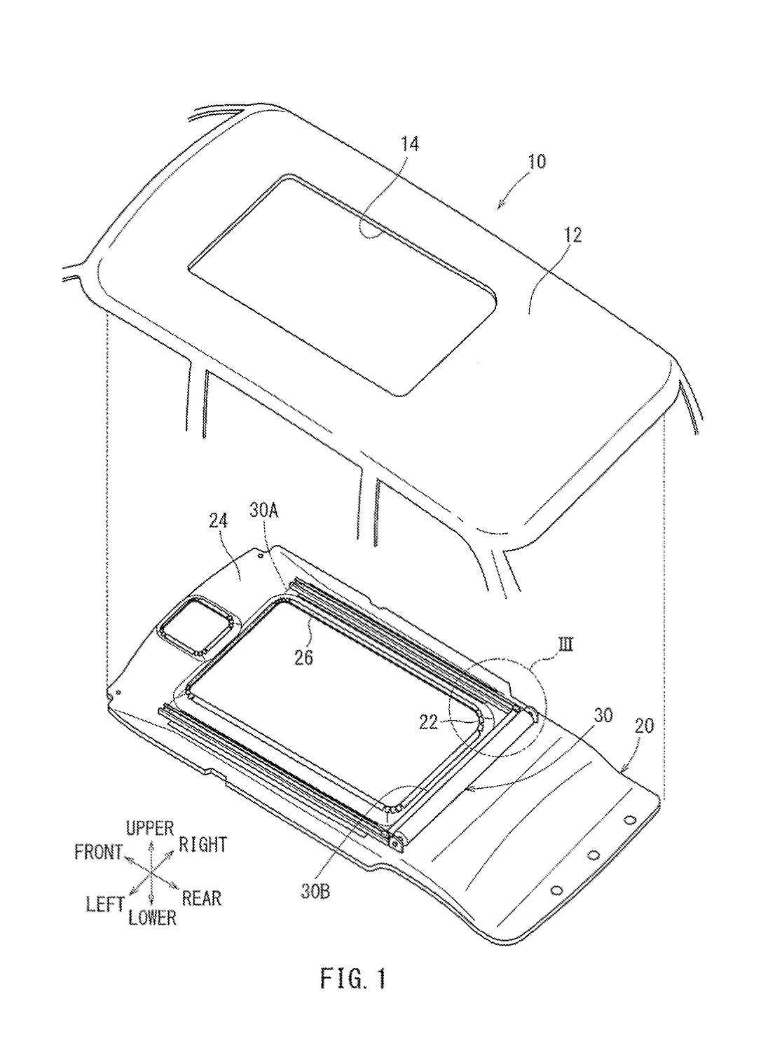

Referring generally to FIGS. 1 through 4, the upper, lower, right, and left directions may be relative to a vehicle 10. As shown in FIG. 1, a vehicle 10, such as a SUV and/or a minivan, may include a roof panel 12, a ceiling member 20 configured to insert into, attach with and/or couple with the roof panel 12, and an opening/closing mechanism 30. The opening/closing mechanism 30 may be positioned on and/or coupled with the ceiling member 20 to face toward the roof panel 12.

As shown in FIG. 1, the roof panel 12 may be constructed from a substantially rigid material, such as steel, aluminum, carbon fiber, composite and/or any combination thereof, to form the roof of the vehicle 10. An aperture 14, such as opening configured to function as a sunroof, moon roof, window, visor and/or the like, may be located in the roof panel 12. Further, the aperture 14 may accept, for example, a glass roof where, for example, a transparent, translucent and/or photochromatie glass may be fit in the aperture 14. Further, the ceiling member 20 may be fabricated from and/or include commonly used materials such as plastic, metal, felt, cloth and/or any combination, of the same and may attach to and/or couple with a side of the roof panel 12 that faces the interior of the vehicle 10 as shown in FIG. 1, for example.

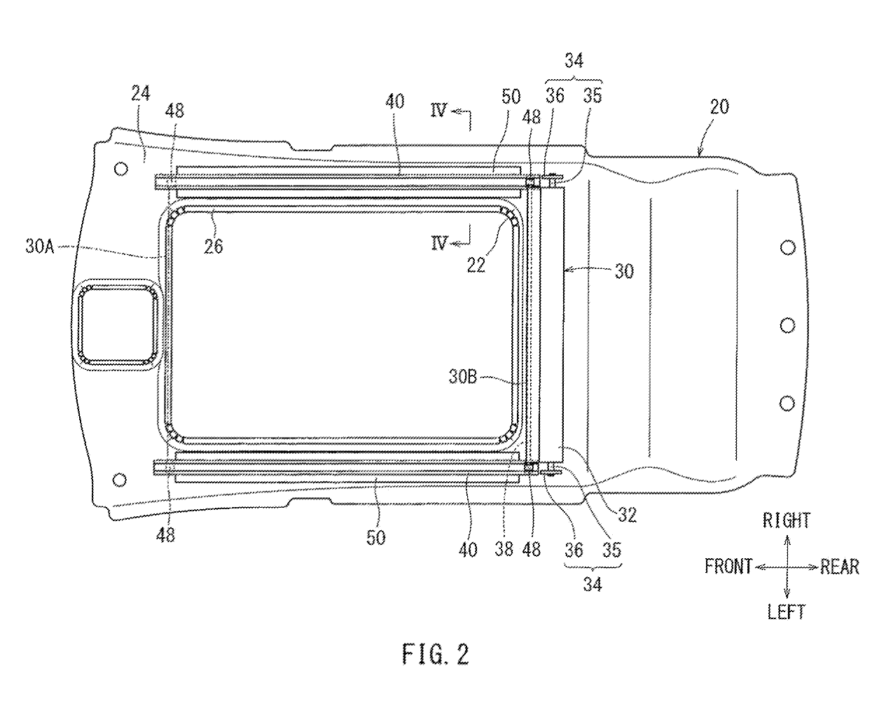

As shown in FIGS. 1 and 2, the ceiling member 20 may insert into and couple with an underside of the roof panel 12 to generally face toward the interior of the vehicle 10. Also, the ceiling member 20 may include a base member 24 and a skin material 26 that is stacked on the underside of the base member 24. The skin material 26 may line a perimeter of the aperture 14 of the roof panel 12. A heat press, for example, may be used to combine the skin material 26 with the base member by heat and/or pressure molding. Further, the skin material 26 may form a seal, for example, around the perimeter of a sunroof opening 22 formed substantially in the center of the ceiling member 20. The base member 24 may enhance the structural rigidity of the ceiling member 20 by providing reinforcement in areas that may, for example, experience flex. Further, the base member 24 may be fabricated from and/or include sound deadening materials to absorb sound to, for example, isolate the interior of the vehicle from ambient road noise during vehicle 10 operation. Also, the base member 24 may have padding to absorb heat to assist in temperature regulation of the cabin of the vehicle 10 as well. In an embodiment, the base member 24 may generally surround a core not shown in the FIGS.).

An adhesive, such as a thermosetting adhesive, may be applied to a top and bottom surface of the core member to bind and/or hold the core member in place relative to the base member 24. Also, a fiber-reinforcing material impregnated with thermosetting adhesive may be applied to and/or stacked on the core. A backing may attach to and/or be glued on the top surface of the core member. In an embodiment, the backing may be a non-breathable film or non-woven cloth composed primarily of thermoplastic synthetic fibers. The configuration, placement and/or construction of the core member may assist the base member 24 in reinforcing and/or enhancing the structural rigidity of the ceiling member 20. Also, the core member may assist the base member 24 in absorbing sound and/or functioning as an insulating material. To this end, various types of materials may be used to form the core, such as cardboard, urethane, olefin foam, other types of like materials and/or any combination of the same. Further, a fiber type material may be applied to the core and/or the base member 24. In an embodiment, a semi-rigid urethane foam layer comprising urethane foam may be used as the core.

The skin material 26 serves as the design of the underside of the ceiling member 20. The skin material 26 may function as, for example, an interface between the ceiling member 20 and the sunroof opening 22. As discussed earlier, the skin material 26 may form a seal around the perimeter of the sunroof opening 22. Further, the skin material 26, when sealed around die. perimeter of the sunroof opening, may protect the base member 24 from deterioration and/or corrosion. In an embodiment, the skin material 26 may be made from a urethane foam sheet stacked above a surface made from cloth material such as fabric, cloth, and/or knitted fabric; cloth such as woven fabric, non-woven fabric, and raised fabric; synthetic leather, simulated synthetic leather substitute, and/or natural leather. A relatively soft layer of urethane resin foam may be used as the urethane foam sheet to provide the ceiling member 20 with, for example, a soft touch and/or feel. Alternatively, the skin material 26 may be fabricated without a urethane foam sheet. Also, in general, the ceiling member 20 may be made and/or configured to correspond with, in terms of shape and/or size, for example, the roof panel 12 of the vehicle 10. In detail, the skin material 26 may be installed on and/or assembled with the ceiling member 20 such that the sunroof opening 22 is aligned with the corresponding aperture 14 of the roof panel 12 to permit for light, i.e. sunlight, entry when desired.

In addition to that described above, the ceiling member 20 may be constructed using lightweight materials to reduce overall vehicle 10 weight. Further, the weight distribution and/or characteristics of the ceiling member 20 may be adapted and/or reconfigured as described below. Should, for example, the ceiling member 20 be moved and/or raised independently, i.e. that is without being attached to the underside of the roof 12 as shown in FIG. 1, for example, the ceiling member may shake, quiver, suffer from deflection, and/or break on account of insufficient structural rigidity. The ceiling member 20, when in a temporarily assembled state, may similarly suffer from deflection and/or breakage where, for example, various vehicle components may be mounted to the ceiling member 20. In contrast to that described above, the ceiling member 20 may maintain a stable configuration, when installed into the roof panel 12. Further, and as described earlier, various well-known materials may be adopted for the construction of the ceiling member 20.

Various types of equipment arch as sun visor and/or an assist grip (not shown in the FIGS.) may be attached to the roof panel 12 via the ceiling member 20. Further, the ceiling member 20 may have one or more holes that correspond to and may be configured to receive and/or connect to such equipment. Similarly; the roof panel 12 may also have mounting holes (not shown. in the FIGS.) that may be aligned with the holes in the ceiling member 20 such that equipment may be passed through and/or connect with both sets of holes, i.e. in the ceiling member 20 and the roof panel 12, by, for example, fixing members such as bolts and nuts, screws, and/or clips. As a result, the ceiling member 20 may be affixed to the roof panel 12. As discussed earlier, the sunroof opening 22 may be positioned near the center of the ceiling member 20 such that the ceiling member 20 surrounds the sunroof opening 22. Such a configuration may result in relatively uniform weight distribution of the ceiling member 20 relative to the sunroof opening 22.

As shown in FIGS. 1 and 2, reinforcing members 50 may be positioned in parallel along the periphery of the opening 22. Such an arrangement of the reinforcing members, i.e. in parallel, may reinforce the periphery of the opening 22 against, for example, flex and/or torsion that may be experienced by the ceiling member 20 during operation of the vehicle 10. In detail, the reinforcing member 50 may be configured and/or constructed as a plate and/or a band, for example, and may be formed from synthetic resin. The reinforcing members 50 may be positioned generally in the front-rear direction, as shown in FIG. 2, along the longitudinal direction of the opening 22 and attached to the ceiling member 20 by an adhesive such as a hot-melt adhesive.

The reinforcing members 50 may have sections, such as an erect rib and/or the like, configured to reinforce the ceiling member 20. Further, the reinforcing members 50 may be hollow. Moreover, in an embodiment, the reinforcing members 50 may be attached to the ceiling member 20 by, for example, a fixing member other than a hot-melt adhesive. Also, the length of the reinforcing members 50 along the opening 22 may be, for example, equal to or longer than the length of side of the opening 22. Further, the lateral length, or width, of the reinforcing members 50 may be set so as not to interfere with the opening 22 and/or the vehicle structure. The reinforcing members 50 may be fabricated from a synthetic resin, for example a thermoplastic resin such as polypropylene resin, polyethylene resin or acrylonitrile butadiene styrene (ABS) resin. Further, a fiber reinforcing material may be mixed with the above-mentioned synthetic resins to enhance the strength of the reinforcing member 50. The fiber reinforcing material may; for example, be one or more of the following materials: non-organic fiber such as glass fiber, organic fibers such as jute, kenaf, ramie, hemp, sisal, and natural fiber such as bamboo.

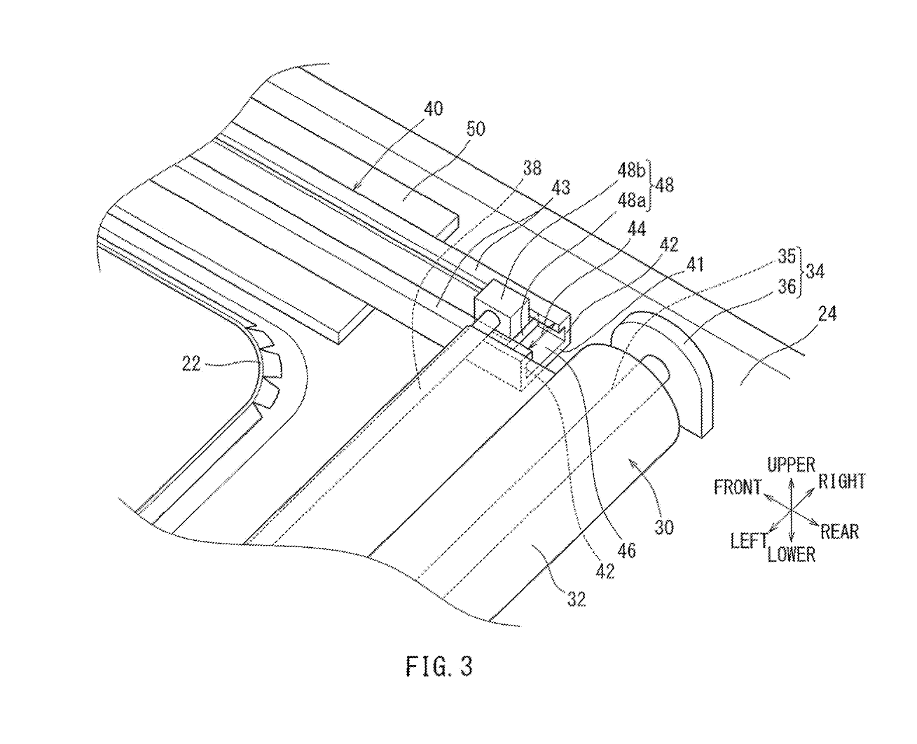

As shown in FIGS. 2 and 3, the opening/closing mechanism 30 may include, for example, a rolled-up sheet member 32 that may be unrolled and/or expanded to cover at least a portion of the opening 22. In detail, the opening/closing mechanism 30 may be positioned between the roof panel 12 and the ceiling member 20. The opening/closing mechanism 30 includes the sheet member 32, a take-up device 34, rail members 40 (guide structures) and sliding members 48. The opening/closing mechanism 30 may have a sheet member 32 wrapped and/or rolled around a roll member 35. The roll member 35 may be positioned and set lengthwise between two corresponding support members 36 to form a take-up device 34. Rail members 40, positioned perpendicular to the take-up device 34 on the ceiling member 20, may receive and/or couple with the sliding member 48. As shown in FIG. 3, the sliding member 48 may be attached to the sheet member 32 such that sliding member 48 may be guided within rail members 40 to pull and/or unroll the sheet member 32 from the take-up device 34 to cover the opening 22. In detail, the sheet member 32 may generally transition from a closed state 30A, where the sheet member 32 may be unrolled and/or expanded from the take-up device 34 to cover the opening 22, and an open state 30B where the sheet member 32 may be rolled up around. the roll member 35 in the take up device 34 to permit light to enter and/or pass through the opening 22. In detail, the sheet member 32, in the closed state 30A, may prevent and/or reduce entrance of light into the vehicle interior from the opening 22. In contrast, the sheet member 32, in the open state 30B, may permit entrance of light into the vehicle interior from the opening 22.

In an embodiment, the sheet member 32 may be fabricated as a generally planar member. The sheet member may be made from, for example, one or more cloth-type materials such as fabric, cloth and/or knitted fabric; a cloth member such as woven fabric, non-woven fabric and raised fabric; and/or synthetic leather, simulated synthetic leather substitute and natural leather.

As shown in FIGS. 2 and 3, the take-up device 34 may be positioned near, for example, a side of the opening 22. In an embodiment, the take-up device 34 may be positioned, for example, near the rear side of the opening 22. Further, and as described earlier, the take-up device 34 can accept and/or roll up the sheet member 32. The sheet member 32 may be reciprocated between a developed state (i.e., where the opening 22 is covered) in which the sheet member 32 has been pulled and/or rolled out of the take-up device 34, and an accommodated state (i.e., where the opening 22 is open) in which the sheet member 32 has been rolled and/or taken up. Further, the take-up device 34 may have a roll member 35 positioned lengthwise between two support members 36, an elastic member (not shown) and a connection member 38. The connection member 38 is attached to the sheet member 32. For example, the connection member 38 may be threaded through the sheet member 32, or bonded with an adhesive, or connected by a rivet.

As shown in FIGS. 2 and 3, the roll member 35 may be shaped generally as a shaft and may be positioned near a side of the opening 22, for example, the rear side thereof. The length of the roll member 35 may be equal to or longer than the length of a side of the opening 22 parallel to the roll member 35, i.e. the rear side. As discussed earlier the roll member 35, within the take-up device 34, may be configured to, for example, recoil and/or wind to wrap the sheet member 32 around the roll member 35. The roll member 35 may be, for example, inserted into and held in place by two support members 36, where each support member 36 is positioned at an end of the roll member 35. Thus, the support members 36 may support and allow the roil member 35 to rotate within the take-up device 34. Further, in an embodiment, an elastic member (not shown in the FIGS.), such as a spring, may attach to the sheet member 32 within the take-up device 34. The elastic member may be uncoiled from an initial position by, for example, pulling the sheet member 32 along the rail members 40 to cover the opening 22, generally toward the closed state 30A. Likewise, the elastic member may wind and/or recoil to return to an initial position to collect and/or take up the roil member 35, i.e. toward the opening state 30B.

As shown in FIGS. 2 and 3, the connection member 38 may be threaded through and/or attached to a forward end, i.e. toward the direction in which the sheet member 32 may be drawn and/or pulled out to cover the opening 22. The connection member 38 may be positioned along the width of the forward end of the sheet member 32 to engage with the sliding members 48 at, for example, both ends of the connection member 38. Further, the sliding members 48 may insert into and slide along the rail members 40. As shown, the connection member 38 spans across the width sheet member 32 to engage with the rail members 40. Thus, the connection member 38 may move and/or be guided along the rail members 40 to pull the sheet member 32 across the opening 22.

As shown in FIGS. 1 and 2, the rail members 40 may be positioned along, for example, peripheral edges of the opening 22. The rail members 40 may extend along a side parallel to the drawing-out direction of the sheet member 32. Thus, as discussed. earlier, the sliding members 48 may insert into and slide and/or be guided along the rail members 40 to allow, for example, the sheet member 32 to alternate between a closed state 30A and an open state 30B. In an embodiment, the rail members 40 may be formed from a relatively lightweight material such as synthetic resin or aluminum alloy. Further, the reinforcing members 50 may be made from one or more synthetic resins.

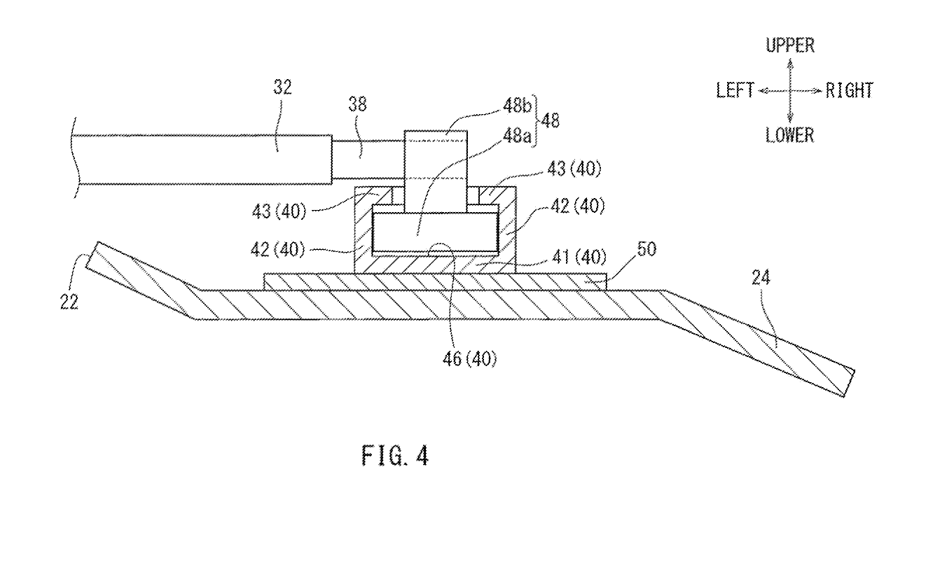

As shown in FIGS. 3 and 4, each rail member 40 may have a bottom surface 41. side surfaces 42 extending from the bottom surface 41, and upper surfaces 43 connected to the side surfaces 42. The bottom surface 41 may be positioned adjacent to and connect with the ceiling member 20. The side surfaces 42 may be positioned in parallel and extend from both ends, in the width direction, of the bottom surface 41. The upper surfaces 43 may be positioned perpendicular to the side surfaces 42 and extend from upper ends of the side surfaces 42 to form the sliding member 48, which, as shown, may generally have a “U”-shaped cross section with a groove portion 44. Further, the groove portion 44 may be situated between the side surfaces 42 and open along the longitudinal direction to define an interior portion 45 in the rail member 40. The interior portion 46 extends in, for example, a straight line parallel to the side surfaces 42 of the rail member 40 to receive and guide the sliding member 48. In detail, as shown in FIG. 4, the interior portion 46 may have a rectangular section. Further, the interior portion 46 may have some other cross-sectional configuration configured to engage with the sliding member 48.

As discussed above, the sliding members 48 may engage with their corresponding rail members 40. In detail, each sliding member 48 includes a sliding portion 48a and a protruding portion 48b attached to the sliding portion 48a. The sliding portion 48a may be inserted into the interior portion 46 of the rail member 40 as shown in FIG. 3. The protruding portion 48b extends from the sliding portion 48a to protrude through the groove portion 44. Further, the sliding portion 48a may be wider than the opening width of the groove portion 44 to, for example, remain engaged with the upper surfaces 43 and the bottom surface 41 of the rail member 40. Thus, the sliding portion 48a may slide in the longitudinal direction along the rail member 40 without, for example, disengaging from the rail member 40. Likewise, the protruding portion 48b may move along the groove portion 44 in correspondence with movement of the protruding portion 48b.

In an embodiment, the sliding portion 48a may be configured to rub and/or slide against the bottom surface 41 of the rail member 40 to experience friction. Such friction may hold the sliding portion 48a in a desired position within the rail member 40 against, for example, the elastic member pulling the sheet member 32 back toward the take-up device 34. As discussed earlier, ends of the connection member 38 are connected to the protruding portions 48b. Also, the sliding members 48 slide, for example, on the rail members 40 in the longitudinal direction to thus correspondingly move connection member 38 in the longitudinal direction of the rail members 40 as well. As a result, the sheet member 32 may move in the longitudinal direction of the rail members 40 and be held in place as desired by the sliding portion 48a, i.e. in either the closed state 30A or the open state 30B.

As described above, the connection member 38 may be threaded through the sheet member 32 to attach to the forward end of the sheet member 32. Further, since the ends of the connection member 38 may attach to the sliding members 48, movement of the sliding members 48 along the rail members 40 may correspondingly pull the sheet member 32 out from the take-up device 34. Also, in an embodiment, a sliding portion that corresponds to the sliding portions 48a may be integrally formed with the sheet member 32. For example, both end portions of the forward end of the sheet member 32 may have such sliding portions as described above. Accordingly, the rail members 40 may directly receive and/or guide the sliding portions of the sheet member 32.

As shown in FIG. 3, reinforcing members 50 may be positioned between the ceiling member 20 and the rail member 40. Also, in an embodiment, the rail members 40 may integrally bind with the reinforcing members 50 by, for example, fusion-bonding. Further, each rail member 40 and each reinforcing member 50 may be formed as one member.

As described above, the opening/closing mechanism 30 may be attached to the ceiling member 20. In detail, the opening/closing mechanism 30 may be integrally mounted to the roof panel 12 and the ceiling member 20. Accordingly the opening/closing mechanism 30 and the ceiling member 20 may be attached and/or assembled simultaneously to the roof panel 12. In detail, the aperture 14 of the roof panel 12 may be aligned with the opening 22 of the ceiling member 20, i.e. to allow light to enter and/or pass through both openings, while assembling the opening/closing mechanism 30 with the ceiling member 20. Thus, the opening/closing mechanism 30 may be simultaneously positioned relative to the ceiling member 20 with respect to the roof panel 12. Moreover, in an embodiment, the opening/closing mechanism 30 and the ceiling member 20 may be attached in an upward-facing direction toward the roof panel 12 as shown in FIG. 1. Also, as a result, simultaneous mounting of the opening/closing mechanism 30 and the ceiling member 20 to the roof panel 12 may reduce overall manufacturing costs.

As described above, the opening/closing mechanism 30 may be positioned between the roof panel 12 and the ceiling member 20. Thus, the opening/closing mechanism 30 need not be exposed to the vehicle interior except, for example, the sheet member 32.

As discussed earlier, the opening/closing mechanism 30 includes the rail members 40 that may guide the sheet member 32 between the closing state 30A and the opening state 3013. The rail members 40 may be arranged to extend along the periphery of the opening 22 of the ceiling member 20. Thus, the sheet member 32 may be transitioned as desired between the closing state 30A and the opening state 30B.

The ceiling member 20 may be relatively thin and constructed of lightweight materials. As discussed earlier, movement of the ceiling member 20 independently, i.e. that is without being attached to the underside of the roof 12 may result in the ceiling member suffering from flex and/or deflection. However, when the ceiling member 20 is mounted to the roof panel 12, the ceiling member 20 may be relatively more resistant to unwanted flex and thus remain in, for example, a fixed position. The ceiling member 20 may be attached to the roof panel 12 as a single piece or in a temporarily assembled state in which various vehicle equipments may be mounted to the ceiling member. However, the ceiling member 20, as discussed earlier, may flex during attachment with the roof panel 12. Flex, deflection and/or other types of undesirable movement, such as quivering, for example, in the ceiling member 20 may be greater closer to the opening 22. To address deflection related issues as described above, the reinforcing members 50 may be positioned along the periphery of the opening 22 of the ceiling member 20 to provide structural reinforcement as needed. Further, in an embodiment, the rail member 40 may be integrally formed with the reinforcing member 50. Such an integral structure of the rail member 40 integrally formed with the reinforcing member 50 may reinforce the ceiling member 20 as needed to prevent deflection, for example, while receiving and/or guiding the sheet member 20 to cover the opening 22 as needed.

As discussed earlier, the opening/closing mechanism 30 may include the sheet member 32 in, for example, a rolled-up state and the take-up device 34 to collect and/or take-up the sheet member 32. As a result, the opening/closing mechanism 30 may be attached to the roof panel 12 relatively simply and/or easily.

While the embodiments of invention have been described above with reference to specific configurations, it will be apparent to those skilled in the art that many alternatives, modifications and variations may be made without departing from the spirit and scope of the present invention. Accordingly, embodiments of the present invention are intended to embrace all such alternatives, modifications and variations that may fall within the spirit and scope of the appended claims. Embodiments of the present invention should not be limited to the representative configurations, but may be modified, for example, as described below.

For example, the guide structure as generally described above may have the reinforcing members 50 formed integrally with the rail members 40. Also, the ceiling member 20 may be assembled and/or constructed without reinforcing members 50. Further, in an embodiment, reinforcing members 50 and the rail members 40 may be integrally installed in the periphery of the opening 22, or may be separately installed near the periphery of the opening 22.

Further, guide structures such as the rail members 40 and the reinforcing members 50 may be assembled and/or combined through fusion bonding, for example. In addition, the reinforcing members 50 and the guide structures may be connected by some other fastening means such as adhesive, clips, or fastening members. Moreover, the rail members 40 may be formed from different materials than reinforcing members 50. Also, in an embodiment, the reinforcing members 50 and the guide structures may be formed in single member. Further, in an embodiment, the reinforcing member 50 and each guide structure may be formed of the same synthetic resin as a single member through, for example, extrusion molding. Also, when the reinforcing member 50 and the guide structure may be integrated, either the reinforcing members 50 or the guide structures may be mounted to the ceiling member 20.

Moreover, the rail members 40 may be constructed from a lightweight material such as synthetic resin, aluminum alloy and/or a combination of the same. Accordingly, the weight of the rail members 40 may be minimized. Further, synthetic resin may allow for a relatively high degree of freedom of movement, for example, of the rail members 40 relative to the ceiling member 20.

Also, in an embodiment, the rail members 40 alone may provide sufficient structural reinforcement to the ceiling member 20. Thus, the ceiling member 20 may be attached to and/or configured with the roof panel 12 without the reinforcing members 50 to, for example, reduce weight as needed.

Further, in an embodiment, the opening/closing mechanism 30 may be attached to the roof panel 12. Also, the opening/closing mechanism may be attached on an interior side surface of the ceiling member 12. Further, the reinforcing members 50 may be arranged on and/or attached to the roof panel 12. Also, the reinforcing members 50 may be arranged on and/or attached to the interior side surface of the ceiling member 20, or between the roof panel 12 and the ceiling member 20. As discussed earlier, should the rail members provide sufficient rigidity to reinforce the peripheral area of the opening 22 of the ceiling member 20, the reinforcing members 50 may be omitted.

As described above, the opening/closing mechanism 30 may include the take-up device 34. Alternatively, the opening/closing mechanism 30 may be, for example, an accommodating device that may fold and/or wind to hold the sheet member, or an expanding device that may expand as an elastically expandable sheet member, for example. Further, the take-up device 34 may manually operated and/or rotated to collect the sheet member 32. Also, in an embodiment, the take-up device 34 may be equipped with an automatic take-up mechanism that may automatically collect the sheet member 32 by a drive source such as electric power or hydraulic pressure.

As described above, the sliding members 48 may be attached to the front corners of the sheet member 32. Alternatively or additionally, sliding members may be attached on the right and/or left edges of the sheet member 12. For example, the sliding members may be attached along the right and/or left edges of the sheet member 32 at certain intervals. Or the sliding members may be elongated along with the right and/or left edges of the sheet member 32.

What is claimed is:

1. A vehicle ceiling, comprising:
a roof panel formed with an aperture;
a ceiling member attached to the roof panel to face toward a vehicle interior wherein the ceiling member is formed with an opening in correspondence to the aperture of the roof panel; and
an opening/closing mechanism coupled to the ceiling member Wherein the opening/closing mechanism deploys a sheet member to reciprocate between a closed state and an open state, wherein the sheet member, in the closed state, covers the opening to suppress entrance of light into the vehicle interior through the opening, and further wherein the sheet member, in the open state, is stowed away from the opening to permit light entrance into the vehicle interior through the opening and the aperture.

2. The vehicle ceiling of claim 1, wherein the opening/closing mechanism is positioned between the roof panel and the ceiling member.

3. The vehicle ceiling of claim 1, further comprising:
a reinforcing member that extends along a periphery of the opening wherein the reinforcing member reinforces the ceiling member.

4. The vehicle ceiling of claim 1, wherein the opening/closing mechanism has a guide structure configured to guide movement of the sheet member along the ceiling member.

5. The vehicle ceiling of claim 4, wherein the guide structure extends along a periphery of the opening.

6. The vehicle ceiling of claim , wherein a reinforcing member is integrally formed with the guide structure.

7. The vehicle ceiling of claim 4, further comprising:
a sliding member configured to engage with the guide structure on the ceiling member.

8. The vehicle ceiling of claim 7, further comprising:
a connection member coupled to the sliding member wherein the connection member is attached to the sheet member.

9. The vehicle ceiling of claim 1, wherein the opening/closing mechanism is a roll shade with a take-up device configured to collect the sheet member.

10. The vehicle ceiling of claim 1, wherein the opening is aligned with the aperture to permit light entrance to the vehicle interior.
